(19) United States
(12) Patent Application Publication
(10) Pub. No.: US 2026/0076495 A1
(43) Pub. Date: Mar. 19, 2026

(54) Disposable Pillowcase System

(71) Applicant: Edward Burke, New York, NY (US)

(72) Inventor: Edward Burke, New York, NY (US)

(21) Appl. No.: 19/401,294

(22) Filed: Nov. 25, 2025

Related U.S. Application Data
(63) Continuation-in-part of application No. 18/734,571, filed on Jun. 5, 2024.

(51) Int. Cl. A47G 9/02; A47G 9/10; B32B 3/26; B32B 5/26

(52) U.S. Cl. CPC A47G 9/0253; A47G 9/1027; B32B 3/266; B32B 5/26; A47G 2009/1018; B32B 2250/20; B32B 2307/7265

(57) ABSTRACT

A disposable pillowcase system has a top layer opposing a bottom layer. Each of the top layer and the bottom layer has sheets and a bottommost sheet. Each of the top layer and the bottom layer have edges. The disposable pillowcase is configured to form an opening by having the top layer joined and bound to the bottom layer perimetrically along the edges. Each sheet of the top layer has perforations perimetrically disposed within the joined and bound edges. Each sheet of the bottom layer has perforations perimetrically disposed within the joined and bound edges. The disposable pillowcase may also have a gusset.

### CROSS-REFERENCE TO RELATED APPLICATIONS

This application is a continuation-in-part of U.S. patent application Ser. No. 18/734,571, filed Jun. 5, 2024, currently pending, entitled Disposable Pillowcase System, which is hereby incorporated by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to pillowcases and cushion coverings. Generally, pillowcases are used and washed once a week. Between launderings, the pillowcase may become soiled (e.g., bacteria). Many times, the pillowcase exhibits no signs of being soiled. For users, soiled pillowcases may have negative effects on users'skin (e.g., acne). The present invention provides users the advantage of having a clean pillowcase as needed (even daily) in a convenient, cost-effective, and speedy manner. The present invention may be utilized in congregate living facilities (e.g., personal care homes, assisted living residences, retirement homes, etc.) and dormitories (colleges, boarding schools, summer camps, etc.).

### BRIEF SUMMARY OF THE INVENTION

An object of the present invention is a disposable pillowcase system comprising a top layer opposing a bottom layer. Each of the top layer and the bottom layer comprises a plurality of sheets and a bottommost sheet. Each of the top layer and the bottom layer comprises a plurality of edges. The disposable pillowcase is configured to form an opening by having the top layer joined and bound to the bottom layer perimetrically along the plurality of edges. Each sheet of the top layer has a plurality of perforations perimetrically disposed within the joined and bound plurality of edges. Each sheet of the bottom layer has a plurality of perforations perimetrically disposed within the joined and bound plurality of edges.

In another object of the present invention, one side of each sheet comprises a comfort side and a non-permeable side.

In yet another object of the present invention, the disposable pillowcase system further comprises at least one foam core tube, which is adapted to be inserted between the top layer and the bottom layer.

In another object of the present invention, each bottommost sheet has a plurality of perforations perimetrically disposed within the joined and bound plurality of edges.

In yet another object of the present invention, the disposable pillowcase system further comprises a non-permeable sheet, which is adapted to be inserted between the plurality of sheets of the top layer and is adapted to be inserted between the plurality of sheets of the bottom layer.

In another object of the present invention, the disposable pillowcase system further comprises an inflatable bladder, which is adapted to be inserted between the top layer and the bottom layer.

In yet another object of the present invention, a disposable pillowcase system comprises a top layer opposing a bottom layer and a gusset. Each of the top layer and the bottom layer comprises a plurality of sheets. Each of the top layer and the bottom layer comprises a plurality of edges. The disposable pillowcase is configured to form an opening by having the top layer and the bottom layer joined and bound to the gusset perimetrically along the plurality of edges. Each sheet of the top layer has a plurality of perforations perimetrically disposed within the joined and bound plurality of edges. Each sheet of the bottom layer has a plurality of perforations perimetrically disposed within the joined and bound plurality of edges.

### BRIEF DESCRIPTION OF THE SEVERAL VIEWS OF THE DRAWING

The advantages and features of the present invention will be better understood as the following description is read in conjunction with the accompanying drawings, wherein:

FIGS. 1A and 1B are illustrations of embodiments of the present invention.

FIGS. 2A and 2B are illustrations of embodiments of sheets of the present invention.

FIGS. 3A and 3B are illustrations of embodiments of connectors of the present invention.

FIG. 4 illustrates embodiments of the present invention.

FIG. 5 is an illustration of an embodiment of sheets of the present invention.

FIG. 6 illustrates an embodiment of an inflatable bladder of the present invention.

FIGS. 7A and 7B are illustrations of embodiments of the present invention.

FIGS. 8A and 8B are illustrations of embodiments of the present invention.

FIGS. 9A, 9B and 9C are illustrations of embodiments of the present invention.

For clarity purposes, all reference numerals may not be included in every figure.

### DETAILED DESCRIPTION OF THE INVENTION

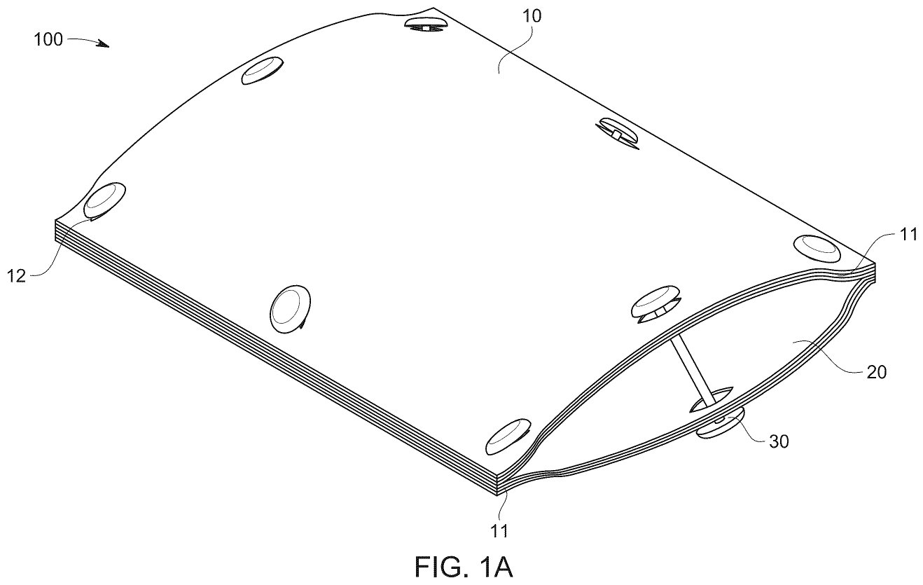

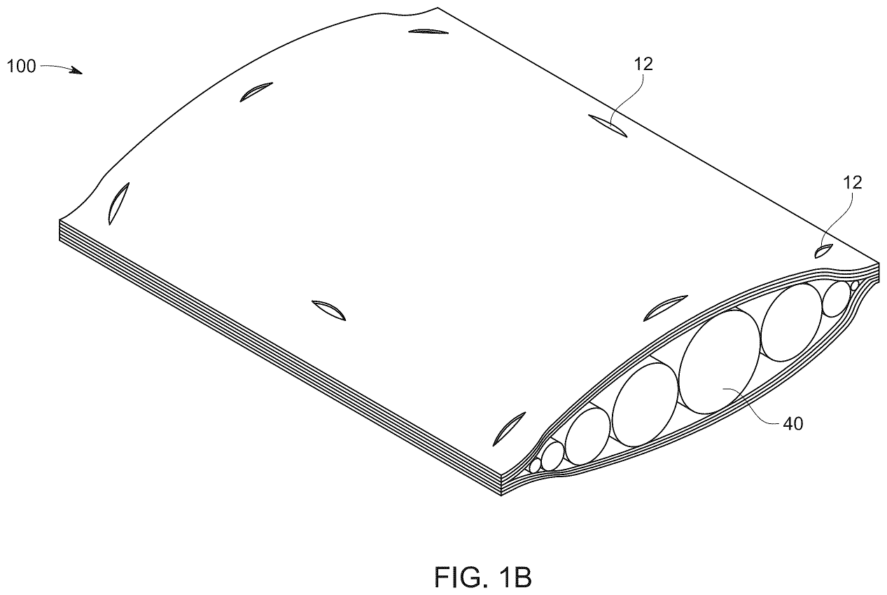

As illustrated in FIGS. 1-3, a disposable pillowcase system 100 comprises a top layer 10, a bottom layer 20, and a plurality of connectors 30. Each of the top layer 10 and the bottom layer 20 comprises a plurality of sheets 11 and each sheet 11 comprises a plurality of slits 12. Each connector 30 is adapted to secure the top layer 10 to the bottom layer 20. Each connector 30 is adapted to be inserted through the slits 12.

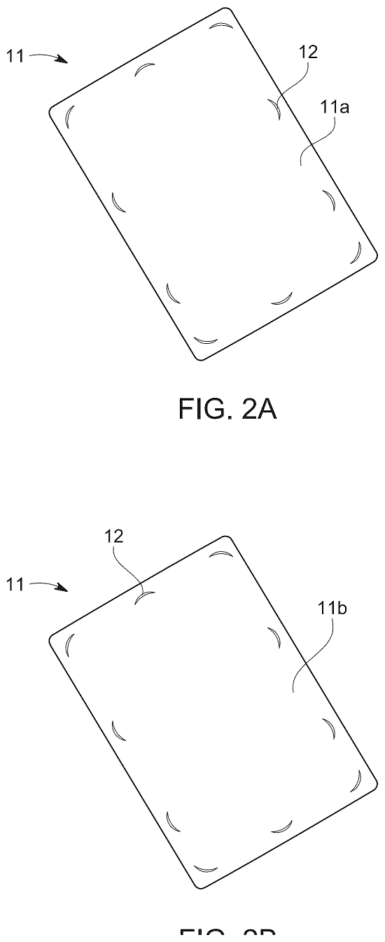

Preferably, one side of each sheet comprises a comfort side 11a and a non-permeable side 11b, as illustrated in FIGS. 2A and 2B, respectively. Each sheet 11 of the top layer 10 and the bottom layer 20 may be made of the suitable pillowcase materials known in the art. For example, the material may be cotton, linen, velvet, satin, silk, polyester, other known pillowcase materials, or combinations thereof. Additionally, the sheets 11 may be made from paper pulp (from wood or fiber crops). The sheets 11 may also be woven, non-woven, or knitted. The non-permeable side 11b is water resistant or waterproof. Each sheet 11 may be made by bonding a suitable pillowcase material to a non-permeable material. Alternatively, each sheet may be a suitable pillowcase material where the sheet has been treated on one side where that side becomes non-permeable (i.e., the non-permeable side 11b) and where the other non-treated side is the comfort side 11a. The comfort side 11a is the side that contacts the user. The non-permeable side 11b acts as a barrier, preventing contaminants from soiling the other sheets 11.

The user may utilize the user's own pillow for the disposable pillowcase system 100. Alternatively, the disposable pillowcase system 100 may further comprise at least one foam core tube 40, as shown in FIG. 1B (no connectors 30 are illustrated in this figure for clarity purposes only). The foam core tube 40 may be inserted into the cavity formed between the top layer 10 and the bottom layer 20. As illustrated in FIG. 1B, more than one foam core tube 40 may be inserted into the cavity. However, some embodiments may be where only one foam core tube 40 may be utilized to fill the cavity if the foam core tube 40 is appropriately shaped. Additionally, although the FIG. 1B illustrates that the foam core tubes 40 are different sizes and form a generally double-tapered shape, the present invention is not limited to such an embodiment. Different size foam core tubes 40 may be utilized to fit the user's specific preferences.

In other embodiments, the disposable pillowcase system 100 may further comprise an inflatable bladder 50, as illustrated in FIG. 6. The inflatable bladder 50 may be inflated for use with the disposable pillowcase system 100. The inflatable bladder 50 may be inserted between the top layer 10 and the bottom layer 20. The inflatable bladder 50 may be deflated for the user's convenience (e.g., storage, travel, etc.). For example, the disposable pillowcase system 100 may be used as a travel pillow. As a flight traveler, the user for convenience may wait until the user is seated on a plane before inflating the inflatable bladder 50 to use the disposable pillowcase system 100. Additionally, the user may deflate the inflatable bladder 50 before deplaning.

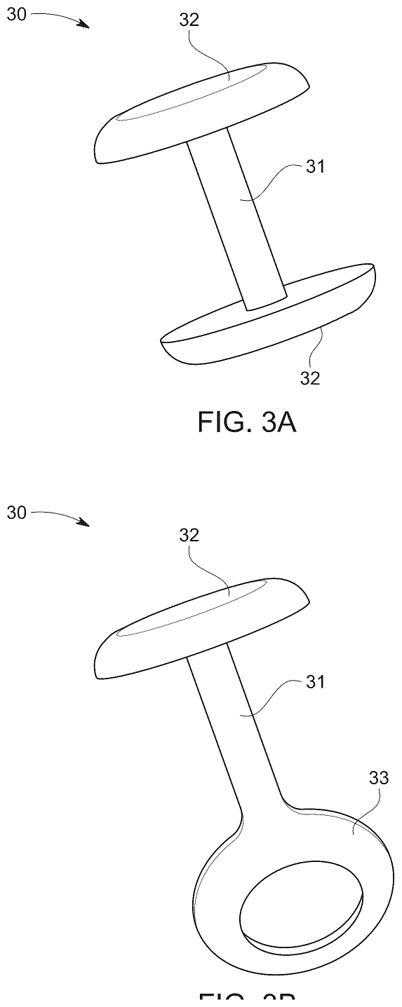

In some embodiments of the present invention. As illustrated in FIG. 3A, the connector 30 may comprise a post 31 having a foot 32 on both ends of the post 31. Each foot 32 is adapted to be inserted through the slits 12.

In other embodiments, the connector 30 may comprise a post 31 having a foot 32 on one end of the post 31 and a loop 33 on the other end of the post 31, as shown in FIG. 3B. The foot 32 is adapted to be inserted through the slit 12. The foot 32 is adapted to be inserted through the loop 33.

The connector 30 is preferably flexible and elastic, where the user may deform (e.g., contract, distort, compress, etc.) any or all of the post 31, foot 32, and loop 33 to allow the user to more easily insert the connector 30 through the slits 12. The connector's 30 elasticity allows the connector to resume its normal shape after the insertion of the connector 30 through the slits 12 is complete. The connector 30 may be made of a flexible material such as soft, pliable, medical-grade biocompatible polymers, such as silicones, resins, plastics, and nylons. Other more rigid materials may be utilized, for example, stainless steel. If more rigid materials are utilized, then the sheet 11 would be stretched thereby widening the slit 12 to allow the insertion of the connector 30 through the slit 12. This is similar to the process of inserting rigid cuff links through button holes. The connectors 30 preferably may be cleaned and reused. Furthermore, the shape and design of the connector 30 is not limited to those shown in FIGS. 3A and 3B, as long as the connector 30 is able to be inserted through the slit 12 and secures the top layer 10 to the bottom layer 20. For example, the connector 30 may be shaped like a keyring (e.g., wire keychain with twist lock, carabiner, etc.). Furthermore, the connector 30 may be any apparatus (e.g., zip ties and string) that may secure the top layer 10 to the bottom layer 20 through the slits 11.

To utilize the connector 30 shown in FIG. 3A, either foot 32 may be inserted through the slits 12 of the top layer 10 and the bottom layer 20. The top layer 10 is secured to the bottom layer 20, where one foot 32 is on the outer surface (i.e., the surface in contact with the user) of the top layer 10 and other foot 32 is on the outer surface (i.e., the surface in contact with the bed) of the bottom layer 20. This connector 30 is similar to the way a cuff link is utilized. FIG. 1A illustrates the use of this connector 30. One of the connectors 30 in this figure is stretched for illustration purposes. When this connector 30 is released, it will return to a normal state where it is not stretched (i.e., it will be shorter) and will secure the top layer 10 closer to the bottom layer 20.

To utilize the connector 30 shown in FIG. 3B, the foot 32 may be inserted through the slits 12 of the top layer 10 and the bottom layer 20. The top layer 10 is secured to the bottom layer 20, where the foot 32 is on the outer surface (i.e., the surface in contact with the user) of the top layer 10 and the loop 33 is on the outer surface (i.e., the surface in contact with the bed) of the bottom layer 20. The foot 32 may then be inserted through the loop 33. Preferably, this connector 30 is made of a soft, pliable, medical-grade biocompatible polymers, such as silicone, which may be stretched and then retracted back into its original shape. The loop 33 may be stretched for ease of insertion of the foot 32. Then, the loop 33 retracts back to its original shape, which better secures the connector 30, which would better secure the top layer 10 to the bottom layer 20.

The present invention is a pillowcase that has disposable sheets 11. The top layer 10 is comprised of sheets 11 stacked on top of each other, where the slits 12 are aligned. Similarly, the bottom layer 20 is also comprised of sheets 11 stacked on top of each other, where the slits 12 are aligned. Then, the top layer 10 is placed upon the bottom layer 20, resulting in the slits 12 of the top layer 10 and the bottom layer 20 being aligned. This alignment allows the connector 30 to be inserted through the slits 12 of both the top layer 10 and the bottom layer 20, resulting in the top layer 10 being secured to the bottom layer 20. The number of slits 12 and connectors 30 may vary depending upon the design of the pillow to be encased. Additionally, all slits 12 may have connectors 30. Alternatively, not all slits 12 may have connectors 30. The amount of connectors 30 will vary depending upon the number needed to secure the pillow within the pillowcase. The user may remove one or more soiled topmost sheets 11 from either the top layer 10, the bottom layer 20, or both. The number of sheets removed may be based on soil or contamination level, user preference, etc. The user may remove a sheet 11 from the top layer 10, then flip the pillow over to have a cleaner bottom layer contact the user the next time the pillow is utilized. The frequency (twice daily, daily, every 3 days, weekly, etc.) of removing a sheet 11 depends upon many factors, such as the user's preference, level of soiling of the sheet 11, etc. To remove a sheet 11, the user may free the sheet from the connector 30. Alternatively, the user may rip the sheet 11 (e.g., for sheets 11 made from paper pulp) away from the connector 30.

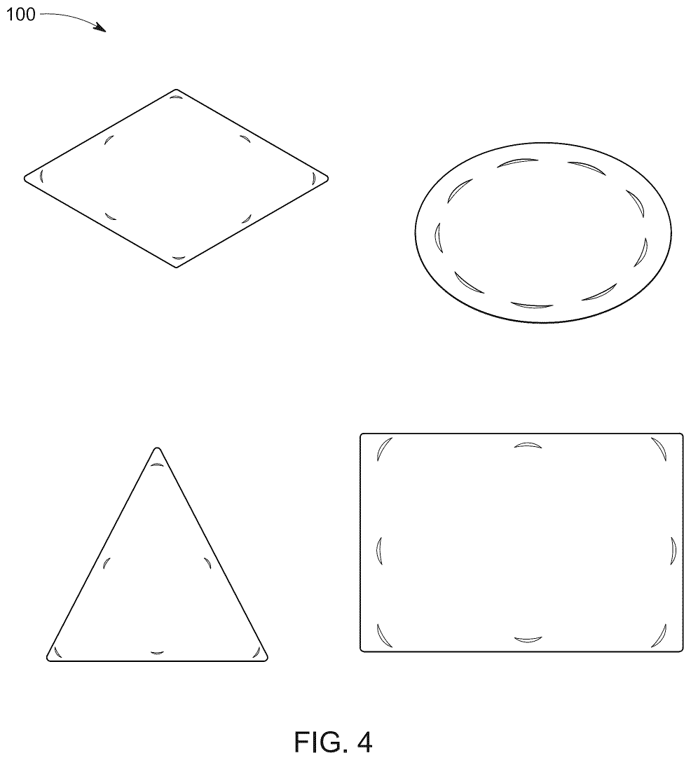

Generally, pillowcases are rectangular. However, the present invention is not limited in shape, as FIG. 4 illustrates different embodiments of the present invention, where the disposable pillowcase system 100 may be different shapes.

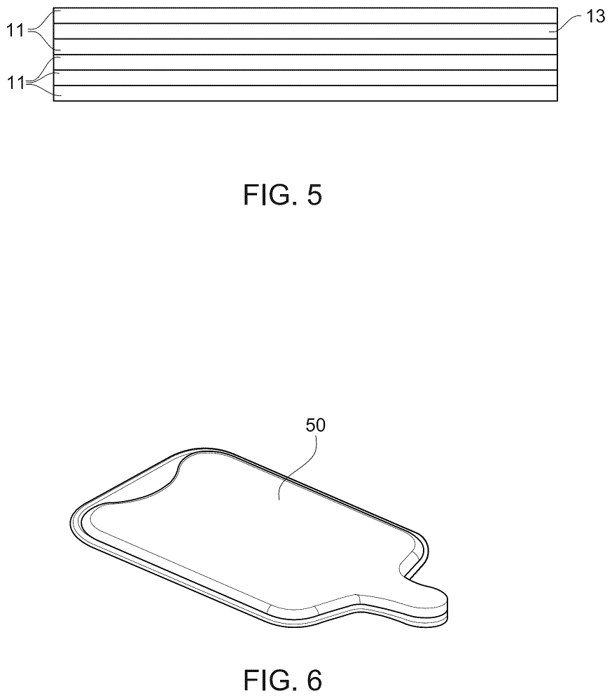

In another embodiment of the present invention, the disposable pillowcase system 100 may comprise a non-permeable sheet 13, as shown in FIG. 5. The non-permeable sheet 13 is adapted to be inserted between the plurality of sheets 11 of the top layer 10. Additionally, the non-permeable sheet 13 is adapted to be inserted between the plurality of sheets 11 of the bottom layer 20. The non-permeable sheet 13 in FIG. 5 may be placed between the plurality of sheets 11 of either or both the top layer 10 and the bottom layer 20. Preferably, the non-permeable sheet 13 is inserted between the top most sheet (i.e., the sheet closest to the user and furthest from the cavity between the top layer 10 and bottom layer 20) and the next sheet. The non-permeable sheet 13 acts as a barrier, preventing contaminants from soiling the next sheet. The non-permeable sheet may be cleaned and laundered to be reused. The sheets 11 preferably serve to absorb and wick away liquids. For example, if the user is prone to drooling, then the sheets act to draw the drool away from the surface and allow the user to lay on a more dry surface. Depending upon the user's preferences and needs, the non-permeable sheet 13 may be inserted between any of the sheets 11. For example, if the user is an excessive drooler, then the user may prefer to insert the non-permeable sheet 13 between the third and fourth sheet 11 (with the topmost sheet 11 being the sheet in contact with the user). This orientation allows more sheets (three in this example) to absorb or wick away the drool.

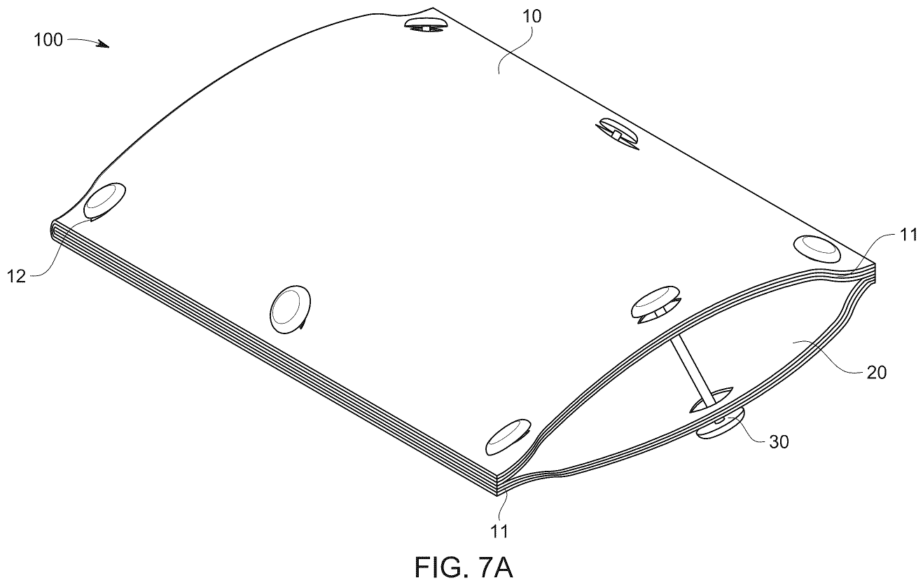

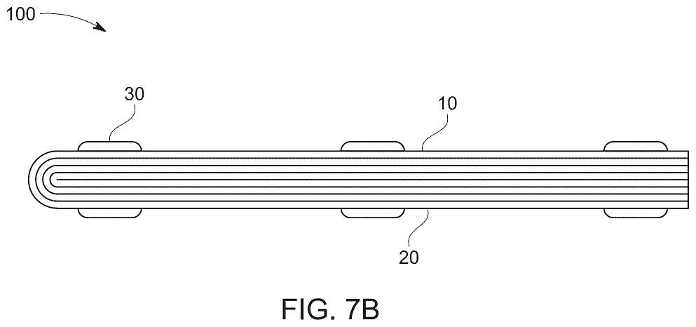

FIGS. 7A and 7B illustrate alternative embodiments of the present invention. Top layer 10 and bottom layer 20 are formed by continuous sheets 11 folded in half, whereby the top half forms the top layer 10 and the bottom half forms the bottom layer 20. When the topmost sheet 11 of the top layer 10 becomes soiled and the user may cut the edge formed where the sheets 11 are folded, remove the soiled sheet 11, and then flip the pillowcase system 100 over allowing the user to sleep on the clean topmost sheet 11 of the bottom layer 20. When the topmost sheet 11 of the bottom layer 20 becomes soiled, the user may then remove the soiled sheet 11.

Alternatively, after the topmost sheet 11 of the top layer 10 is soiled, the user may then flip the pillowcase system 100 over allowing the user to sleep on the clean topmost sheet 11 of the bottom layer 20. When the topmost sheet 11 of the bottom layer 20 becomes soiled, the user may then remove both the soiled sheet 11 of the top layer 10 and the bottom layer 20 together.

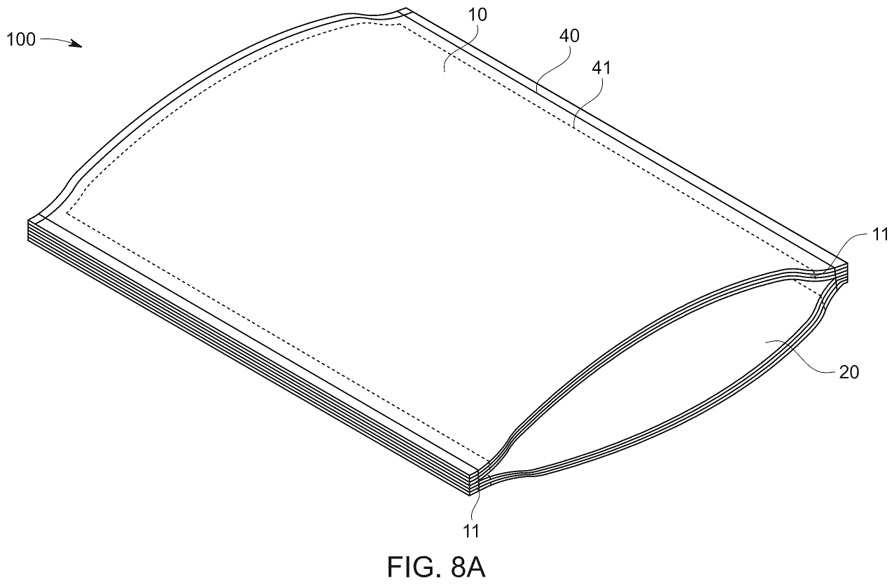

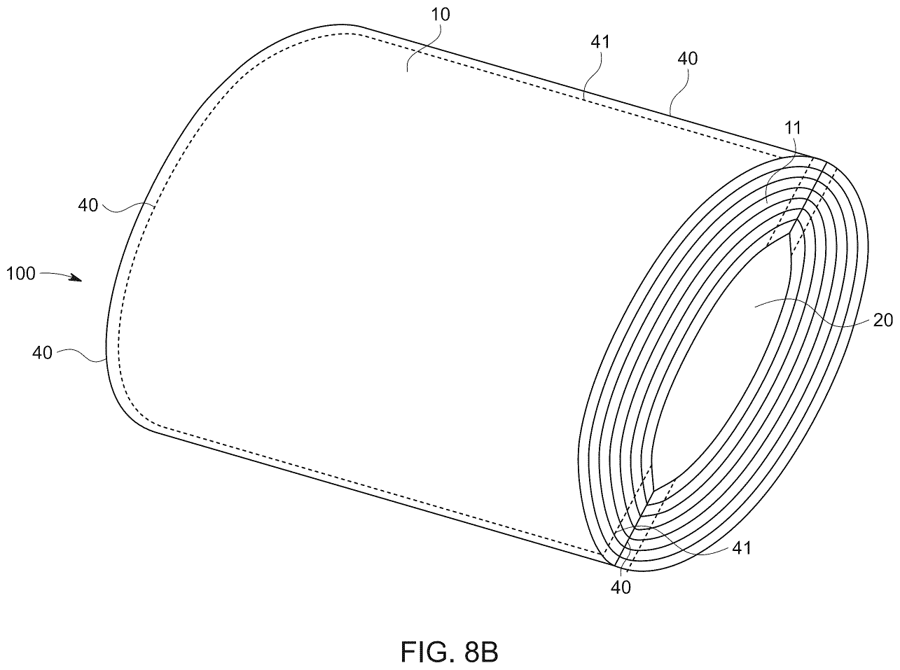

In other embodiments of the present invention, as shown in FIGS. 8A and 8B, the top layer 10 is joined and bound to the bottom layer 20 perimetrically along a plurality of edges 40. Each sheet 11 of the top layer 10 has a plurality of perforations 41 disposed within the joined and bound plurality of edges 40. Each sheet 11 of the bottom layer 20 has a plurality of perforations 41 disposed within the joined and bound plurality of edges 40. Because the plurality of perforations 41 are disposed within the joined and bound plurality of edges 40, the pillowcase 100 retains its structural integrity when sheets 11 are removed. The perforations 41 are configured to allow a user to tear off the topmost sheets 11 of the top layer 10 and bottom layer 20, when the user determines a clean sheet 11 is needed. Advantageously, if the topmost sheet 11 of the top layer 10 is soiled, then the user may remove that soiled sheet 11, flip the pillow and pillowcase 100 over to use the clean sheet 11 of the bottom layer 20. Alternatively, the user may remove the topmost sheets 11 from both the top layer 10 and bottom layer 20 at the same time, if the user so desires. With regard to the perforations 41, the perforation strength would be of suitable strength to allow the user to tear easily, but would not tear easily from general handling and use of the pillowcase 100, as one skilled in the art understands. The perforation strength is determined by many factors, such as the perforation density, the properties of the material, the perforation characteristics, etc.

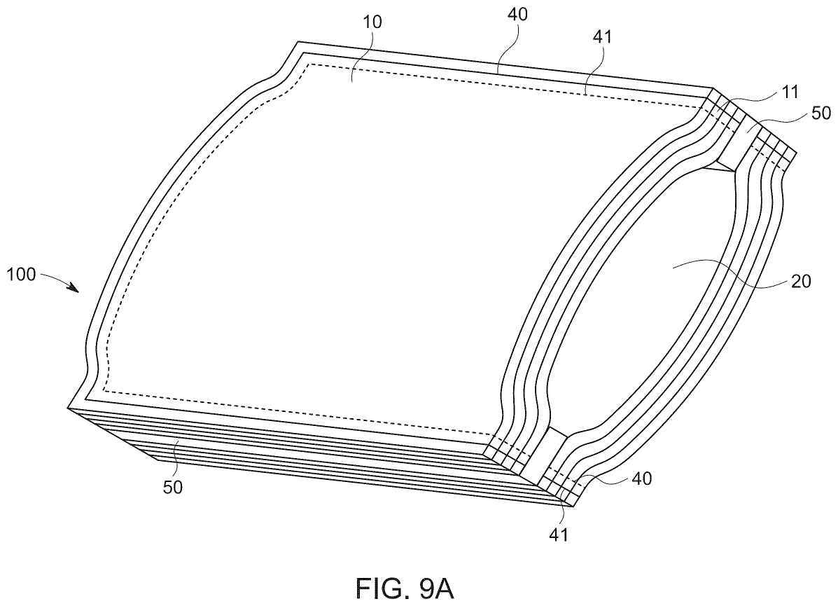

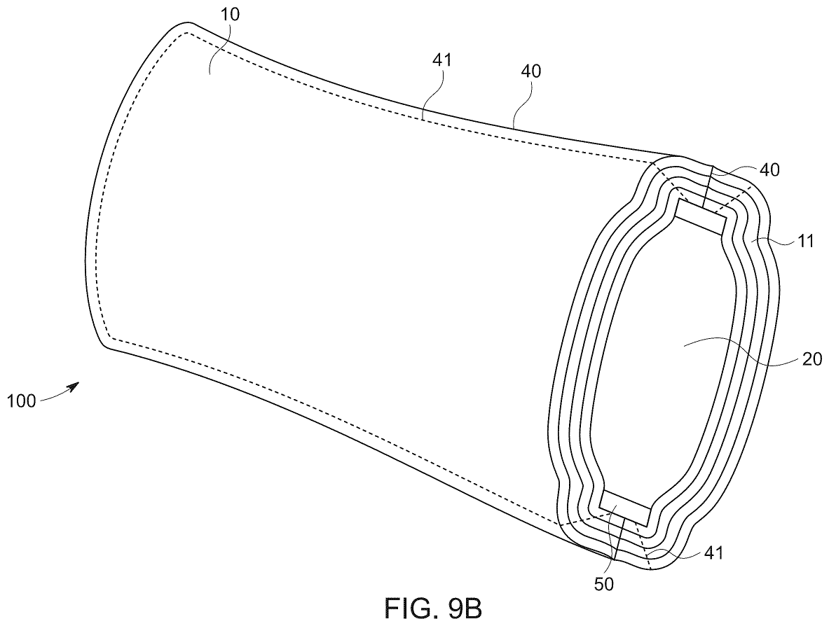

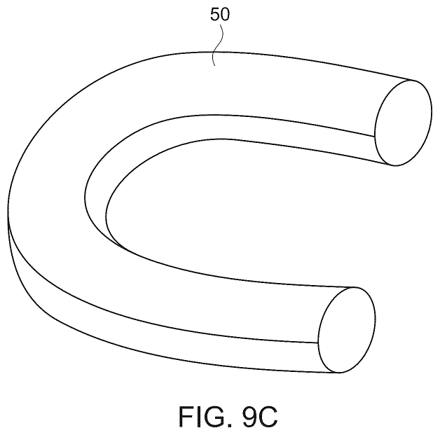

In another embodiment, as shown in FIGS. 9A, 9B and 9C, the pillowcase 100 may also comprise a gusset 50. The top layer 10 and the bottom layer 20 are joined and bound to the gusset 50 perimetrically along the plurality of edges 40. The gusset 50 may serve to provide the pillowcase 100 with more structure and rigidity. The pillowcase 100 may be configured where the gusset 50 may be visible to the exterior of the pillowcase 100 (as illustrated in FIG. 9A) or where the gusset 50 is not visible to the exterior of the pillowcase 100 (as illustrated in FIG. 9B). FIG. 9C shows the gusset 50 being similar in shape (in this instance, being C or U shaped) to the pillowcase 100 illustrated in FIGS. 9A and 9B. As one in the art appreciates, pillows/cushions and associated pillowcases may be in different shapes and sizes. Accordingly, a proper sized and shaped gusset will be used for different pillowcases. The gusset 50 may be configured to allow for the pillowcase 100 to have rounded edges and corners (called fillets in engineering terms), which allows optimal support to resist tearing of the perforations from normal pillow use and handling. The rounded edges and corners may act to reduce the stress on the perforations, which in turn reduces accidental tearing of the perforations.

The bottommost sheets 11 (the sheets in direct contact with the pillow) may or may not have perforations. If the bottommost sheet 11 does not have perforations 41, then the user will not be able to easily tear the bottommost sheet 11, which would indicate to the user that the user has reached the bottommost sheet 11. Additionally, the bottommost sheet 11 may have a backing perimetrically along the edges. The backing may provide support and shape to the pillowcase 100.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, top, bottom, etc. do not denote any order or importance, but rather the terms first, second, top, bottom, etc. are used to distinguish one element from another.

I claim:

1. A disposable pillowcase system comprising:
a top layer opposing a bottom layer;
wherein each of the top layer and the bottom layer comprises a plurality of sheets and a bottommost sheet;
wherein each of the top layer and the bottom layer comprises a plurality of edges;
wherein the disposable pillowcase is configured to form an opening by having the top layer joined and bound to the bottom layer perimetrically along the plurality of edges;
wherein each sheet of the top layer has a plurality of perforations perimetrically disposed within the joined and bound plurality of edges; and,
wherein each sheet of the bottom layer has a plurality of perforations perimetrically disposed within the joined and bound plurality of edges.

2. The disposable pillowcase system of claim 1, wherein one side of each sheet comprises a comfort side and a non-permeable side.

3. The disposable pillowcase system of claim 1 further comprising at least one foam core tube;
wherein the at least one foam core tube is adapted to be inserted between the top layer and the bottom layer.

4. The disposable pillowcase system of claim 1, wherein each bottommost sheet has a plurality of perforations perimetrically disposed within the joined and bound plurality of edges.

5. The disposable pillowcase system of claim 1 further comprising a non-permeable sheet;
wherein the non-permeable sheet is adapted to be inserted between the plurality of sheets of the top layer; and,
wherein the non-permeable sheet is adapted to be inserted between the plurality of sheets of the bottom layer.

6. The disposable pillowcase system of claim 1 further comprising an inflatable bladder;
wherein the inflatable bladder is adapted to be inserted between the top layer and the bottom layer.

7. A disposable pillowcase system comprising:
a top layer opposing a bottom layer; and, a gusset;
wherein each of the top layer and the bottom layer comprises a plurality of sheets;
wherein each of the top layer and the bottom layer comprises a plurality of edges;
wherein the disposable pillowcase is configured to form an opening by having the top layer and the bottom layer joined and bound to the gusset perimetrically along the plurality of edges;
wherein each sheet of the top layer has a plurality of perforations perimetrically disposed within the joined and bound plurality of edges; and,
wherein each sheet of the bottom layer has a plurality of perforations perimetrically disposed within the joined and bound plurality of edges.

8. The disposable pillowcase system of claim 7, wherein one side of each sheet comprises a comfort side and a non-permeable side.

9. The disposable pillowcase system of claim 7 further comprising at least one foam core tube;
wherein the at least one foam core tube is adapted to be inserted between the top layer and the bottom layer.

10. The disposable pillowcase system of claim 7 further comprising a non-permeable sheet;
wherein the non-permeable sheet is adapted to be inserted between the plurality of sheets of the top layer; and,
wherein the non-permeable sheet is adapted to be inserted between the plurality of sheets of the bottom layer.

11. The disposable pillowcase system of claim 7 further comprising an inflatable bladder;
wherein the inflatable bladder is adapted to be inserted between the top layer and the bottom layer.

12. The disposable pillowcase system of claim 7, wherein each bottommost sheet has a plurality of perforations perimetrically disposed within the joined and bound plurality of edges.
